(19) United States
(12) Patent Application Publication
(10) Pub. No.: US 2012/0106132 A1
(43) Pub. Date: May 3, 2012

(54) LED LAVA LIGHT

(76) Inventor: Tseng-Lu CHIEN, Walnut, CA (US)

(21) Appl. No.: 12/938,798

(22) Filed: Nov. 3, 2010

(51) Int. Cl. F21V 33/00

(52) U.S. Cl. 362/101

(57) ABSTRACT

The LED Lava Light of current invention consist of motor means, propeller means, 1^{st} magnetic means, 2^{nd} magnetic means, freely move base, LED(s), circuit means, control means, timer means, sensor means, trigger means, conductive means to make the propeller moved to make liquid flow moving so inside miniatures staff will change position to come out splendid light effects of LED LAVA light. The current invention do not has toxic liquid, heat means to make a big improvement for safety and prevent from fire hazard.

This filing related to co-inventor's prior patent application Ser. Nos.

12-624,621, 12-622,100, 12-318,471, 12-318,470, 12-318,473, 12-292,153, 12-232,505, 12-232,035, 12-149,963, 12-149,964, 12-073,095, 12-073,889, 12-007,076, 12-003,691, 12-003,809, 11-806,711, 11-806,285, 11-806,284, 11-566,322, 11-527,628, 11,527,629, 11-498,874, 12-545,992, 12-806,711, 12-806,285, 12-806,284, 12-566,322, 12-527,628, 12-527,629, 12-527,631, 12-502,661, 11-498,881, 11-255,981, 11-184,771, 11-152,063, 11-094,215, 11-092,742, 11-092,741, 11-094,156. 11-094,155, 10-954,189, 10-902,123, 10-883,719, 10-883,747, 10-341,519, 12-545,992, 12-292,580, 12-710,918, 12-622-000 12-710,561, 12-710, 12-711,456, 12-771,003

This is patent application related to co-inventor's prior filing Ser. No. 12-771,003 Filed on Apr. 30, 2010 for LED has plurality of project means

This is patent application related to co-inventor's prior filing Ser. No. 12-711,456 Filed on Feb. 25, 2010 for LED power failure Light

This is patent application related to co-inventor's prior filing Ser. No. 12-710,561 Field on Feb. 25, 2010 for LED light device has special effects

This is patent application related to co-inventor's prior filing Ser. No. 12-710,918 Field on Feb. 25, 2010 for LED light device has more than 1 reflective means for plurality of image

This is patent application related to co-inventor's prior filing Ser. No. 11-24-2009 file for the “project device or assembly for variety of LED light”,

This is patent application related to co-inventor's prior filing Ser. No. 12-622,000 Field on Nov. 24, 2009 file for the “Interchangeable Universal Kits for all LED light”

This is patent application related to co-inventor's prior filing Ser. No. 12-318,471 Field Dec. 30, 2008 file for the “LED night light with pinhole imaging”

This is patent application related to co-inventor's prior filing Ser. No. 12-318,470 Field Dec. 24, 2008 file for the “LED night light with Projection features”

This is patent application related to co-inventor's prior filing Ser. No. 12-318,473 Field Dec. 8, 2008 file for the “LED night light with laser or hologram element”

This is patent application related to co-inventor's prior filing Ser. No. 12-292,153 Field Nov. 8, 2008 file for the “LED night light with Projection or imaging features”

This is patent application related to co-inventor's prior filing Ser. No. 12-232,505 Field Sep. 16, 2008 file for the “LED night light with Projection features”

This is patent application related to co-inventor's prior filing Ser. No. 12-149,963 Filed on Apr. 21, 2008 file for the “Removable LED light device.

This is patent application related to co-inventor's prior filing Ser. No. 12-149,964 Filed on Apr. 21, 2008 file for the “Surface Mounted Device with LED light”.

This is patent application related to co-inventor's prior filing Ser. No. 12-073,095 Filed on Feb. 29, 2008 file for the “LED Track light device.

This is patent application related to co-inventor's prior filing Ser. No. 12/073,889, filed on Feb. 12, 2008 file for the “LED light with changeable position with Preferable power source”.

This is patent application related to co-inventor's prior filing Ser. No. 12/007,076, filed on Jan. 7, 2008 file for the “LED light with changeable geometric system”

This is patent application related to co-inventor's prior filing Ser. No. 12/003,691, filed on Dec. 31 , 2007 file for the “LED light with changeable geometric dimension features”

This is patent application related to co-inventor's prior filing Ser. No. 12/003,809, filed on Jan. 2, 2008 file for the “LED light with changeable features”

This is patent application related to co-inventor's prior filing Ser. No. 11/806,711 filed on Apr. 30, 2007 file for the “Multiple LED light with adjustable angle features”

This is patent application related to co-inventor's prior filing Ser. No. 11/806,285. LED Night light with outlet device filed on Apr. 30, 2007

This is patent application related to co-inventor's prior filing Ser. No. 11/806,284 LED Night light with more than 1 optics means filed on Apr. 28, 2007

This is patent application related to co-inventor's prior filing Ser. No. 11/527,628. Multiple function Night light with air fresher filed on Sep. 27, 2006.

This is patent application related to co-inventor's prior filing Ser. No. 11/527,629. LED Night light with interchangeable display unit filed on Sep. 27, 2006.

This is patent application related to co-inventor's prior filing Ser. No. 11/498,874. Area illumination Night light filed on Aug. 4, 2006.

This is patent application related to co-inventor's prior filing Ser. No. 11/527,631. LED Time piece night light field on Sep. 27, 2006.

This is patent application related to co-inventor's prior filing Ser. No. 12-545,992 LED time piece Night light filed division of Ser. No. 11-527,631 on Aug. 24, 2009.

This is patent application related to co-inventor's prior filing Ser. No. 12-292,580 LED Time Piece Night light filed division of Ser. No. 11-527,631 on Aug. 24, 2009.

This is patent application related to co-inventor's prior filing Ser. No. 11/498,881, Poly Night light filed on Aug. 4, 2006.

This is patent application related to co-inventor's prior filing Ser. No. 11/255,981, Multiple light source Night Light filed on Oct. 24, 2005.

This is patent application related to co-inventor's prior filing Ser. No. 11/184,771 Light Device with EL elements field on Oct. 11, 2005

This is patent application related to co-inventor's prior filing Ser. No. 11/1152,063 Outlet adaptor with EL field on Jun. 5, 2005

This is patent application related to co-inventor's prior filing Serial No.

This is patent application related to co-inventor's prior filing Ser. No. 11/094,215, filed Mar. 30, 2005 LED Night light with Liquid optics medium.

This is patent application related to co-inventor's prior filing Ser. No. 11/092,741, filed Mar. 30, 2005 Night light with fiber optics.

This is patent application related to co-inventor's prior filing Ser. No. 10/883,747, filed Jul. 6, 2004 Fiber Optic light kits for footwear.

This is patent application related to co-inventor's prior filing Ser. No. 11/498,874, Area Illumination for LED night light

This is patent application related to co-inventor's prior filing Ser. No. 11/527,629. Time Piece with LED night light,

This is patent application related to co-inventor's prior filing Ser. No. 11/527,628. Multiple Function Night light with Air Freshener

This is patent application related to co-inventor's prior filing Ser. No. 11/806,284 LED Night light with more than one optics mediums

This is patent application related to co-inventor's prior filing Ser. No. 11/806,285 LED Night Light with multiple function

This is patent application related to co-inventor's prior filing Ser. No. 11/806,711 Multiple LEDs Light with adjustable angle function

Above listed prior filing case related apply physic optic theory to the said LED light for outdoor or indoor application powered by alternative current (hereafter as AC) or direct current (hereafter as DC) connect by the electric cored & its plug for outlet, or battery, or transformer, or solar, or other power source which same as current invention to apply the physics optics theory to create plurality of LED light beam to make illumination for the said close area(s), or remote-away distanced-area(s) by said project means which present to viewers which may further incorporate with same inventor's other features which may in any combination from the selection including more than 1 light source, more than 1 function, more than 1 optics means, more than 1 project means with super power saving circuit and cost saving concept.

### BACKGROUND

The current invention related to the LED Lava light which has no any toxic liquid material within the compartment. It also do not has the heater means which may cause big fire hazard while over heat happened.

The current invention for LED Lava Light use the timer motor incorporate with magnetic means to make the propeller rotating to make the liquid flow and inner miniatures to move to make splendid motion moving for illumination.

The current invention overcome the (1) Toxic liquid (2) No heat hazard is big improvement for the LED Lava prior filing cases.

### DRAWINGS

FIG. 1: Disclosure the 1^{st} embodiment with liquid container has propeller and magnetic means to make liquid flow and make inside miniatures staff moving, the timer motor has magnetic means to make reaction to propeller's magnetic means so can rotating and make the fluid flow on certain period of time. The build-in LED(s) and circuit means to make the said LED emit the pre-determined function, color, brightness.

FIG. 2: Disclosure the detail construction of the preferred embodiment 1. Show the top cover, liquid container, light passing piece, LED, Base, sensor means, prong means and inner circuit means. The liquid container has variety design of miniatures staff which may in round piece, rectangular pieces, star shape, heart shape, cartoon characters. The light passing piece can be transparent or translucent material basing on market requirement. The LED number can be from one to N (Any number) for desired light performance.

FIG. 3: Disclosure the propeller and magnetic piece has base which glue on the bottom of liquid container. The propeller and magnetic piece are reactive by the motor & its magnetic piece which install on the outside of the liquid container. The motor incorporate with control means to make certain speed and rotating time and duration for rotating so make the inner miniature move in right speed to make eye catching motion effects of miniatures staff.

FIG. 4-1: Disclosure the Battery Powered LED Lava light which has at least motion moving of miniature staff and build-in night light and the motor means incorporate with magnetic means.

FIG. 4-2: Disclosure the AC powered LED Lava light which has at least motion moving of miniature staff and build0in night light and the motor means incorporate with magnetic means.

FIG. 4-3: Disclosure the AC powered LED Lava light which has details construction and at least has more than one LED to make the Lava light has more than one LED emit light beams to different direction which same as co-inventor's prior filing case.

### DETAIL DESCRIPTION

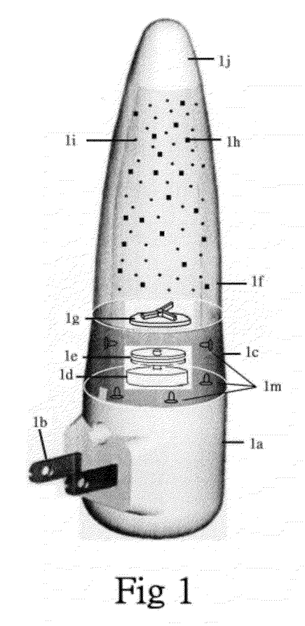

From FIG. 1: Disclosure the 1^{st} embodiment with liquid container (1f) has propeller (1g) and 1st magnetic means (not shown) to make liquid flow and make inside miniatures staff (1h) (1i) moving, the timer motor has 2^{nd} magnetic means (1e) to make reaction to propeller's 1^{st} magnetic means so can rotating and make the fluid flow on certain period of time. The build-in LED(s) and circuit means (not shown) to make the said LED emit the pre-determined function, color, brightness.

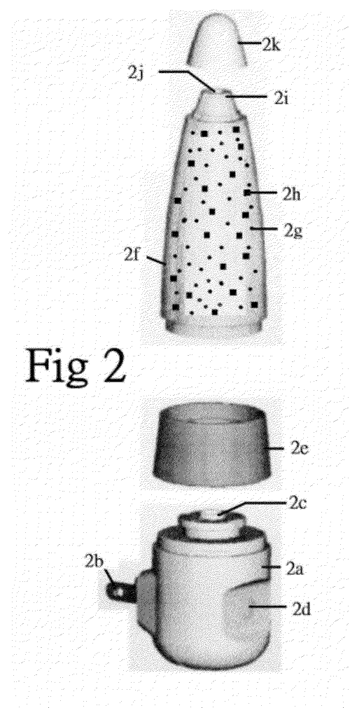

From FIG. 2: Disclosure the detail construction of the preferred embodiment 1. Show the top cover (2k), liquid container (2g), light passing piece (2e), LED (not shown), Base (2a), sensor means (2d), prong means (2b) and inner circuit means (not shown). The liquid container (2f) has variety design of miniatures staff (2g) (2h) which may in round piece (2g), rectangular pieces (2h), star shape, heart shape, cartoon characters.

The light passing piece (2e) can be transparent or translucent material basing on market requirement. The LED number can be from one to N (Any number) for desired light performance.

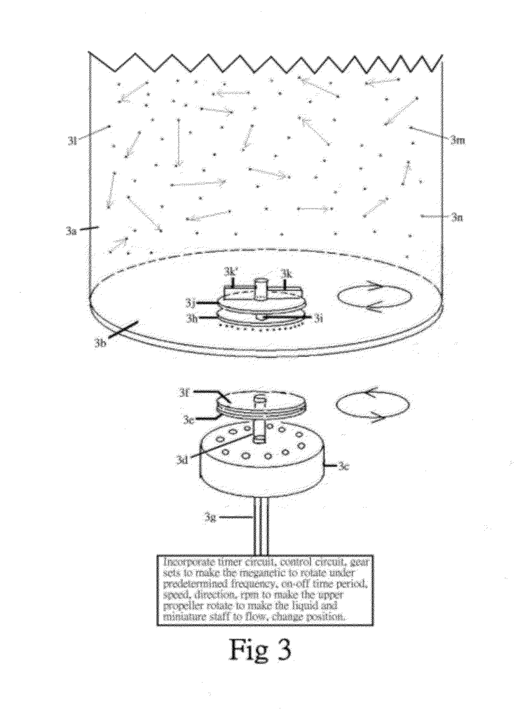

FIG. 3: Disclosure the propeller (3k) (3k′) and 1st magnetic means (3j) has base (3h) which glue on the bottom (3b) of liquid container. The propeller (3k) (3k′) and 1^{st} magnetic means (3j) are reactive by the motor (3c) & 2nd magnetic means (3f) which install on the outside of the liquid container (3a). The motor (3c) incorporate with control means (See notes) to make certain speed and rotating time and duration for rotating so make the inner miniature staff (3l) (3m) (3n) move in right speed to make eye catching motion effects of miniatures staff (3l) (3m) (3n).

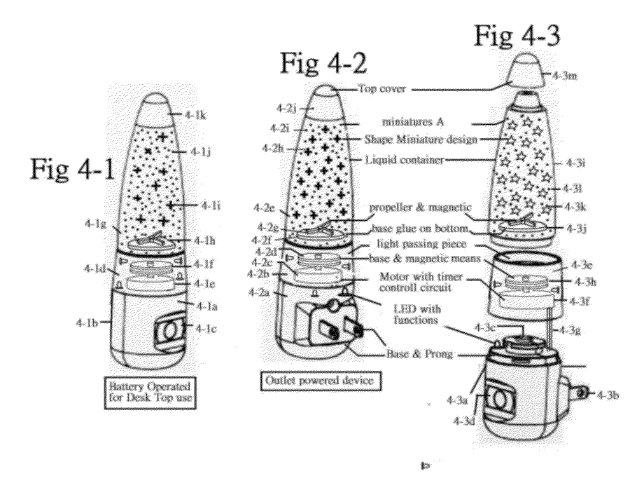

FIG. 4-1: Disclosure the Battery Powered (4-1b) LED Lava light which has at least motion moving of miniature staff (4-1i) (4-1j) (4-1g) and build-in night light (variety LEDs) and the motor means (4-1e) incorporate with 2^{nd} magnetic means (4-1f). The motor means (4-1e) driver the 2^{nd} magnetic means (4-1f) to active the 1^{st} magnetic means and propeller (4-1h) to make the liquid move and make all miniature staff (4-1i) (4-1j) to move. The miniature staff can be reflective piece so can reflect all incoming LED light beams to variety directions to make eye-catching effects. Details see notes on the drawing.

FIG. 4-2: Disclosure the AC powered LED Lava light (4-2a) which has at least motion moving of miniature staff (4-i) (4-2h) and build-in night light and the motor means (4-2c) incorporate with 2nd magnetic means (4-2d) to drive the upper 1^{st} magnetic means and propeller (4-2f) to rotate and make the miniatures staff to moving and reflect all incoming LED light beams to all directions. Details see notes on the drawing.

FIG. 4-3: Disclosure the AC powered LED Lava light (4-3i) which has details construction and at least has more than one LED to make the Lava light has more than one LED (4 LEDs) emit light beams to different direction which same as co-inventor's prior filing case. Details see notes on the drawing.

1. The LED Lava light consist:
At least one of the liquid container has plurality of miniatures staff(s) inside with colorful or reflective properties.
At least one of the propeller has 1st magnetic means and base which fix on the inner bottom of the said liquid container. The said propeller means can be freely rotate on base with tiny resistance.
At least one of the 2nd magnetic means on base are fix on the axis of the motor means and motor means are rotate under pre-determined speed, rotating per second, frequency, duration by control means.
The 2^{nd} magnetic means rotate will activate the 1^{st} magnetic means to make the propeller rotating under desired function.
The rotating propeller will make liquid flow move and make the miniatures staff to moving accordingly to make motion moving effects.
At least one of LED(s) to emit light beam to the liquid container and at least one of 2^{nd} LED(s) to emit light beam to the other direction which is not same as 1^{st} LED(s) to make the night light performance. The said LED Lava light has prong means to connect with outlet or the said LED Lava light has self-power or outside power which may selected from group combination including batteries, adaptor, transformer, energy storage parts and accessories, solar module, wind power, chemical power or other energy forms available from market place.

2. The LED LAVA light consist of;
At least one LEDs incorporate with liquid container, transparent or translucent piece, safety approval LED base, and top cover to form a LED Lava light.
The improvement including:
The said LED Lava light may consist of desired parts and accessories Selected from group combination of motor means, propeller means, 1^{st} magnetic means, 2^{nd} magnetic means, timer means, energy storage means, batteries, prong means, conductive means, free moving base with axis, circuit means, control means, miniature staff in variety designs and size.
The said LED Lava light's miniatures stuff will moving while the said light be powered by prong means or battery means to drive the motor rotating under per-determined on and off per period of time to drive the 2^{nd} magnetic means to active 1^{st} magnetic means to make propeller make liquid moved.
